(19) United States
(12) Patent Application Publication
(10) Pub. No.: US 2002/0080555 A1
(43) Pub. Date: Jun. 27, 2002

(54) Ceramic capacitor and manufacturing method therefor

(75) Inventors: Toshiki Nishiyama, Takefu-shi (JP); Takayuki Nishino, Takefu-shi (JP); Takao Hosokawa, Imadate-gun (JP); Yasunobu Yoneda, Takefu-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/978,366

(22) Filed: Oct. 17, 2001

(30) Foreign Application Priority Data
Nov. 6, 2000 (JP) 2000-337631

(51) Int. Cl. H01G 4/35

(52) U.S. Cl. 361/302

(57) ABSTRACT

A ceramic capacitor made from a ceramic mainly containing a CaZrO₃-CaTiO₃ solid solution exhibiting a high solid solubility is provided. The powder X-ray diffraction pattern of the ceramic satisfies conditions: (X-ray intensity of valley D)/(X-ray intensity of peak B)<0.2; and (X-ray intensity of valley E)/(X-ray intensity of peak B)<0.2, wherein the peak B is assigned to the (121) plane of the CaZrO₃-CaTiO₃ solid solution at approximately 32.0°, the valley D lies at approximately 31.8° between a peak A which is assigned to the (200) plane of the CaZrO₃-CaTiO₃ solid solution detected at approximately 31.6° and the peak B, and the valley E lies at approximately 32.2° between the peak B and a peak C which is assigned to the (002) plane of the CaZrO₃-CaTiO₃ solid solution detected at approximately 32.4°. A manufacturing method therefor is also provided.

### BACKGROUND OF THE INVENTION

1. Field of the Invention

The present invention relates to ceramic capacitors and a manufacturing method therefor. For example, the present invention is directed to a monolithic ceramic capacitor and a manufacturing method therefor.

2. Description of the Related Art

Various methods for manufacturing monolithic ceramic capacitors made of a ceramic containing CaZrO₃-CaTiO₃ as the primary component have been suggested heretofore. One example (first example) of such a method includes calcining in advance CaCO₃, ZrO₂ and TiO₂, which are starting materials for the primary component, adding a sintering aid, a binder, and an organic solvent to the calcined materials to prepare a mixture, blending the mixture for several hours by a wet process to prepare a slurry, shaping the slurry into sheets by using a shaping machine such as a doctor blade, drying the resulting sheets to prepare ceramic green sheets, applying a conductive paste on the ceramic green sheets to form internal electrodes, stacking the ceramic green sheets so that the internal electrodes face one another with the ceramic green sheet therebetween, press-bonding the ceramic green sheets to form a laminate, and sintering the laminate to prepare a ceramic compact having internal electrodes. An electrode paste is then applied to the two ends of the ceramic compact, is dried, and is baked to form external electrodes. The monolithic ceramic capacitor is thereby obtained.

Another example (second example) of the manufacturing method includes adding a binder, an organic solvent and a sintering aid to CaZrO₃ and CaTiO₃ which are starting materials calcined in advance to prepare a mixture, blending the mixture for several hours by a wet process to prepare a slurry, shaping the slurry into sheets using a shaping machine such as a doctor blade, drying the sheets to prepare ceramic green sheets, applying a conductive paste on the ceramic green sheets to form internal electrodes, stacking the ceramic green sheets so that the internal electrodes face one another with the ceramic green sheet therebetween, press-bonding the ceramic green sheets so as to form a laminate, and sintering the laminate to prepare a ceramic compact having internal electrodes. An electrode paste is then applied to the two ends of the ceramic compact, is dried, and is baked to form external electrodes. The monolithic capacitor is thereby obtained.

However, the solid solubility between CaZrO₃ and CaTiO₃ is not sufficient in the CaZrO₃-CaTiO₃-based monolithic capacitors manufactured by conventional manufacturing methods, especially in the CaZrO₃-CaTiO₃-based monolithic capacitors manufactured by the method of the second example described above. The solid solubility between CaZrO₃ and CaTiO₃ affects the reliability of the monolithic capacitors. Particularly, the reliability at high temperatures in the monolithic ceramic capacitor made of a nonreducing material containing CaZrO₃-CaTiO₃ as the primary component is difficult to achieve when the thickness of the ceramic green sheet is approximately 5 μm.

### SUMMARY OF THE INVENTION

It is an object of the present invention to provide a ceramic for use in a ceramic capacitor containing a CaZrO₃-CaTiO₃ solid solution exhibiting a high solid solubility. A manufacturing method therefor is also provided.

To achieve the above object, an aspect of the present invention provides a ceramic capacitor made from a ceramic containing CaZrO₃ and CaTiO₃ as the primary components, CaZrO₃ and CaTiO₃ constituting a CaZrO₃-CaTiO₃ solid solution, wherein a powder X-ray diffraction pattern of said ceramic satisfies the conditions below:

(X-ray intensity of valley D)/(X-ray intensity of peak B)<0.2 (1)

(X-ray intensity of valley E)/(X-ray intensity of peak B)<0.2 (2)

Peak B is a peak in the X-ray diffraction pattern assigned to the (121) plane of the CaZrO₃-CaTiO₃ solid solution detected at approximately 32.0°, valley D is a valley in the X-ray diffraction pattern at approximately 31.8° lying between peak A which is a peak in the X-ray diffraction pattern assigned to the (200) plane of the CaZrO₃-CaTiO₃ solid solution detected at approximately 31.6° and the peak B, and valley E is a valley in the X-ray diffraction pattern at approximately 32.2° lying between the peak B and peak C which is a peak in the X-ray diffraction pattern assigned to the (002) plane of the CaZrO₃-CaTiO₃ solid solution detected at approximately 32.4°.

When above-described conditions (1) and (2) are satisfied, the peak resolution among the peak A in the X-ray diffraction diagram assigned to the (200) plane, the peak B in the X-ray diffraction diagram assigned to the (121) plane, and the peak C in the X-ray diffraction diagram assigned to the (002) plane becomes high. The peak resolution indicates an extent to which an X-ray diffraction peak pattern is separated from the adjacent X-ray diffraction peak pattern. When the peak resolution is high, the solid solubility in CaZrO₃-CaTiO₃ is high.

Another aspect of the present invention provides a method for manufacturing a ceramic capacitor, comprising: calcining starting materials at a temperature between about 1,100° C. and 1,200° C. to obtain a calcined stock, the starting materials being CaCO₃, ZrO₂, and TiO₂; adding at least one auxiliary material to the calcined stock; and sintering the calcined stock at a temperature not less than about 1,300° C. to make a ceramic containing CaZrO₃ and CaTiO₃ as the primary components. By employing this method, a ceramic containing CaZrO₃-CaTiO₃ which satisfies above-described conditions (1) and (2) can be easily obtained.

### BRIEF DESCRIPTION OF THE DRAWINGS

FIG. 1 is an assembly perspective view showing an embodiment of a manufacturing method for a ceramic capacitor according to the present invention;

FIG. 2 is a partially fragmentary view showing an embodiment of a ceramic capacitor according to the present invention; and

FIG. 3 is a powder X-ray diffraction diagram of the ceramic portion of the ceramic capacitor shown in FIG. 2.

### DESCRIPTION OF THE PREFERRED EMBODIMENT

The preferred embodiments of a ceramic capacitor and a manufacturing method therefor according to the present invention will be described below with reference to the drawings by way of Examples.

### EXAMPLE 1

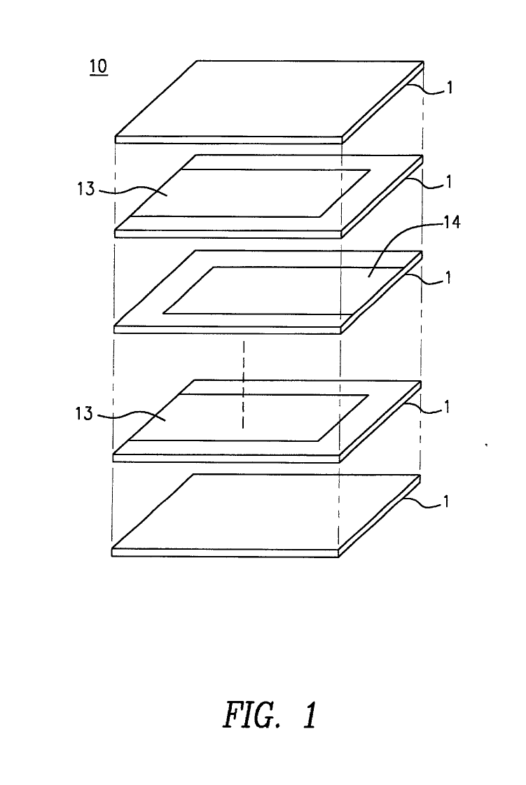

First, CaCO₃, ZrO₂ and TiO₂, which were the starting materials for dielectric ceramic green sheets 1 shown in FIG. 1, were prepared and were weighed to achieve a CaZrO₃/CaTiO₃ molar ratio of 6:4. Subsequently, the starting materials were mixed with a binder and an organic solvent for several hours and were pulverized by a wet process to prepare a slurry. The slurry was dried and then calcined for two hours at temperatures shown in Table 1 to obtain the calcined stocks for Samples 1 to 5.

TABLE 1

| | Sample 1* | Sample 2 | Sample 3 | Sample 4 | Sample 5* |
|---|---|---|---|---|---|
| Calcination | 1,050° C. | 1,100° C. | 1,150° C. | 1,200° C. | 1,250° C. |
| Temperature | | | | | |
| MTTF (hr.) | 46.8 | 216.6 | 253.1 | 262.6 | 128.6 |
| Value m | 0.88 | 4.24 | 4.79 | 5.15 | 2.65 |

Note:
Asterisked samples are not within the scope of the invention.

Each of the calcined stocks was mixed with a binder and an organic solvent blended for several hours, and pulverized by a wet process. A sintering aid containing MnCO₃ and SiO₂ as the primary components was added thereto to again prepare a slurry. The resulting slurry was then shaped into sheets, each approximately 7 μm in thickness, by using a shaping machine such as a doctor blade, and the resulting sheets were dried to obtain the ceramic green sheets 1. A conductive paste containing Cu, Ag, Ag—Pd or Pd, or a base metal such as Ni, etc., was applied by screen printing onto the ceramic green sheets 1 to form internal electrodes 13 and 14.

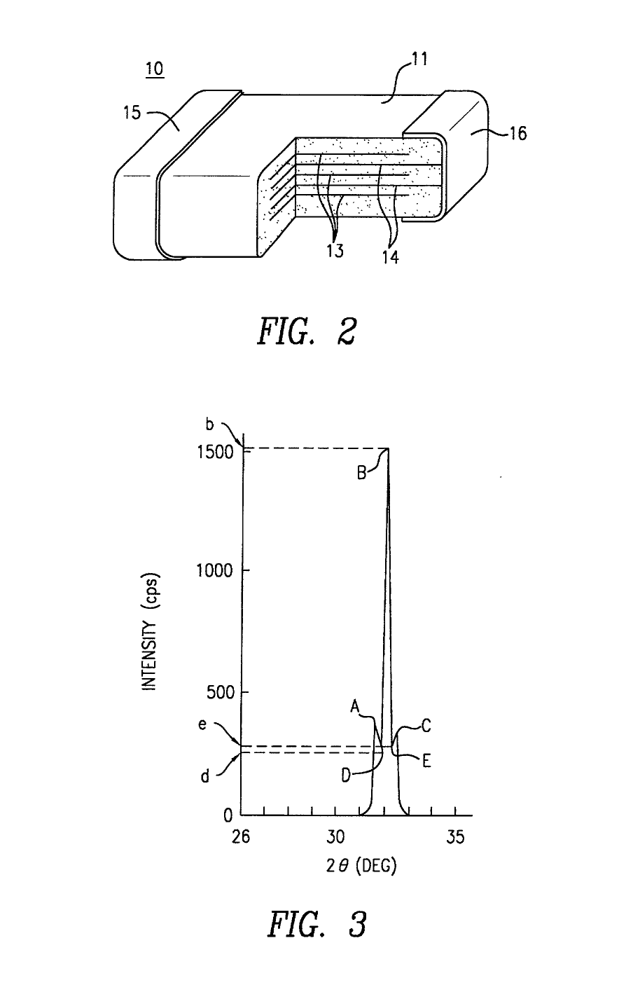

The ceramic green sheets 1 were stacked so that the internal electrodes 13 and 14 opposed each other with the ceramic green sheet 1 therebetween and were press-bonded to form a laminate. The laminate was treated in air for three hours at a temperature of 250° C. to remove the binder therefrom and was then sintered in a reducing atmosphere at a temperature of 1,320° C. for two hours to prepare a ceramic compact 11 shown in FIG. 2. A vertical cross-section of each of Samples 1 to 5 was examined with a microscope, and the distance between the internal electrodes 13 and 14 of the ceramic compact 11 as found to be 4.6 μm for all of the samples.

Next, the ceramic compact 11 was subjected to barrel finishing. Subsequently, an electrode paste containing Cu, Ag, Ag—Pd or the like was applied to the two ends of the ceramic compact 11 by a dipping method or the like, dried and baked to form external electrodes 15 and 16. Next, the surfaces of the external electrodes 15 and 16 were plated with Ni and Sn to prepare a monolithic ceramic capacitor 10.

An accelerated life test (the number of the test pieces n=36) was then performed on the resulting monolithic capacitors 10 of Samples 1 to 5 at 150° C. and 200V. Mean time to failure (MTTF) calculated from the accelerated life test results and values m in the Weibull plot are shown in Table 1 for each of Samples 1 to 5. The value m is a parameter related to the early failure rate. Large MTTF and m values are preferable. In Table 1, the asterisked samples (Samples 1 and 5) are comparative examples which are outside the scope of the present invention. As is apparent from Table 1, the calcination temperature significantly affects the reliability of the ceramic capacitors 10, the MTTF and the value m.

In order to examine the solid solubility between CaZrO₃ and CaTiO₃ constituting the ceramic of the monolithic ceramic capacitor 10, the ceramic portion of each of Samples 1 to 5 was pulverized and was subjected to a structural analysis by a powder X-ray diffraction. The results showed that the X-ray diffraction peaks identifying crystal phases were only the peaks of CaZrO₃-CaTiO₃ solid solution in all Samples 1 to 5 and no different phase was identified. However, when the diffraction patterns were examined in detail, peak resolutions among the three peaks assigned to the (200) plane, the (121) plane and the (002) plane of the CaZrO₃-CaTiO₃ solid solution observed at around 2θ=32°, where θ represents the Bragg angle, were different among the samples.

To be more specific, as shown in FIG. 3, when the X-ray diffraction peak assigned to the (200) plane detected at approximately 2θ=31.6° was represented by A, the X-ray diffraction peak assigned to the (121) plane detected at approximately 2θ=32.0° was represented by B, the X-ray diffraction peak assigned to the (002) plane detected at approximately 2θ=32.4° was represented by C, the valley lying at approximately 2θ=31.8° between the X-ray diffraction peaks A and B was represented by D, and the valley lying at approximately 2θ=32.2° between the X-ray diffraction peaks B and C was represented by E, the ratios of X-ray intensities d and e of the valleys D and E, respectively, to an X-ray intensity b of the main peak B were calculated. The results are shown in Table 2.

TABLE 2

| | Sample 1* | Sample 2 | Sample 3 | Sample 4 | Sample 5* |
|---|---|---|---|---|---|
| Calcination | 1,050° C. | 1,100° C. | 1,150° C. | 1,200° C. | 1,250° C. |
| Temperature | | | | | |
| d/b ratio | 0.221 | 0.187 | 0.166 | 0.158 | 0.184 |
| e/b ratio | 0.228 | 0.196 | 0.182 | 0.177 | 0.203 |

Note: Asterisked samples are not within the scope of the invention.

As is apparent from Table 2, the peak resolutions among the diffraction patterns of the (200), (121) and (002) planes correlate with the reliability results shown in Table 1. High reliability is achieved when the ceramic portion of the monolithic ceramic capacitor 10 satisfies relationships (1) and (2) below:

(X-ray intensity at the valley D)/(X-ray intensity at the peak B)<0.2 (1)

(X-ray intensity at the valley E)/(X-ray intensity at the peak B)<0.2 (2)

In other words, high peak resolutions and high reliability are achieved when the calcination temperature is between about 1,100° C. and 1,200° C. Generally, the solid-solubility of CaZrO₃-CaTiO₃ can be improved by employing higher calcination temperatures; however, the subsequent pulverization by a wet process cannot be performed efficiently in such a case, resulting in degraded sinterability and failing to improve solid solubility of the resulting compact. Thus, it is preferable that the calcination temperature of the starting materials be set at a temperature between about 1,100° C. and 1,200° C.

### EXAMPLE 2

First, CaCO₃, ZrO₂ and TiO₂, which were starting materials for dielectric ceramic green sheets 1 shown in FIG. 1, were prepared and were weighed to achieve a CaZrO₃/CaTiO₃ molar ratio of 6:4. Subsequently, the starting materials were blended with a binder and an organic solvent, for several hours and pulverized by a wet process to prepare a slurry. The slurry was dried and then calcined at 1,150° C. for two hours to obtain a calcined stock.

The calcined stock was blended with a binder and an organic solvent for several hours and pulverized by a wet process. A sintering aid containing MnCO₃ and SiO₂ as the primary components was added thereto to again prepare a slurry. The slurry was then shaped into sheets each approximately 7 μm in thickness by using a shaping machine such as a doctor blade, and the resulting sheets were dried to prepare the ceramic green sheets 1. A conductive paste was applied by screen-printing or the like on the ceramic green sheets 1 to form internal electrodes 13 and 14.

The ceramic green sheets 1 were stacked so that the internal electrodes 13 and 14 opposed each other with the ceramic green sheet 1 therebetween and were press-bonded to form a laminate. The laminate was treated in air for three hours at a temperature of 250° C. to remove the binder therefrom and was then sintered in a reducing atmosphere at temperatures shown in Table 3 for two hours to obtain a ceramic compact 11 shown in FIG. 2. A vertical cross-section of each of Samples 6 to 10 was examined with a microscope, and the distance between the internal electrodes 13 and 14 of the ceramic compact 11 was found to be 4.6 μm for all of the samples.

TABLE 3

| | Sample 6* | Sample 7* | Sample 8 | Sample 9 | Sample 10 |
|---|---|---|---|---|---|
| Sintering | 1,240° C. | 1,270° C. | 1,300° C. | 1,330° C. | 1,360° C. |
| Temperature | | | | | |
| MTTF (hr.) | 174.1 | 218.8 | 264.5 | 271.2 | 288.6 |
| Value m | 1.22 | 1.87 | 4.57 | 4.73 | 5.11 |

Note: Asterisked samples are not within the scope of the invention.

Next, the ceramic compact 11 was subjected to barrel finishing. Subsequently, an electrode paste was applied to the two ends of the ceramic compact 11 by a dipping method or the like, dried and baked to form external electrodes 15 and 16. Next, the surfaces of the external electrodes 15 and 16 were plated with Ni and Sn to complete a monolithic ceramic capacitor 10.

An accelerated life test (the number of test pieces n=36) was then performed on the resulting monolithic capacitors 10 of Samples 6 to 10 at 150° C. and 200V. Mean time to failure (MTTF) calculated from the accelerated life test results and values m in the Weibull plot are shown in Table 3 for each of Samples 6 to 10. The value m is a parameter related to the early failure rate. Large MTTF and m values are preferable. In Table 3, the asterisked samples, i.e., Samples 6 and 7, are comparative examples which are outside the scope of the present invention. As is apparent from Table 3, the sintering temperature significantly affects even the reliability of the ceramic capacitor 10 using the material calcined at a temperature in the suitable range demonstrated in Example 1.

In order to examine the solid solubility in the CaZrO₃-CaTiO₃ contained in the ceramic of the monolithic ceramic capacitor 10, the ceramic portion of each of Samples 6 to 10 was pulverized and was subjected to a structural analysis by a powder X-ray diffraction. The results showed that the X-ray diffraction peaks identifying crystal phases were only the peaks of CaZrO₃-CaTiO₃ solid solution in all Samples 6 to 10 and no different phase was identified. The peak resolutions among the three peaks assigned to the (200), (121) and (002) planes of the CaZrO₃-CaTiO₃ solid solution observed at around 2θ=32° were then examined for each of Samples 6 to 10. That is, as shown in FIG. 3, the ratios of X-ray intensities d and e of the valley D and E to an X-ray intensity b of the main peak B were calculated. The results are shown in Table 4.

TABLE 4

| | Sample 6* | Sample 7* | Sample 8 | Sample 9 | Sample 10 |
|---|---|---|---|---|---|
| Sintering | 1,240° C. | 1,270° C. | 1,300° C. | 1,330° C. | 1,360° C. |
| Temperature | | | | | |
| d/b ratio | 0.206 | 0.187 | 0.169 | 0.161 | 0.159 |
| e/b ratio | 0.211 | 0.201 | 0.184 | 0.178 | 0.176 |

Note: Asterisked samples are not within the scope of the invention.

The results show that while solid-solution formation is mostly achieved by calcination at a temperature in the range determined in Example 1, the solid-solution formation also progresses during sintering. Although a low sintering temperature does not lead to a significant degradation in reliability such as that experienced when the calcination temperature is changed, it leads to a decrease in the value m which is a parameter related to the early failure rate. Thus, the sintering temperature is one of the important control items and is preferably set at a temperature not less than about 1,300° C.

As described above, in the monolithic ceramic capacitor 10 composed of a dielectric material containing CaZrO₃ and CaTiO₃ as the primary components, and MnCO₃ and SiO₂, the solid solubility in CaZrO₃-CaTiO₃ can be improved by optimizing the temperature for calcining the dielectric starting materials and the temperature for sintering the laminate to make the monolithic capacitor 10. Thus, a highly reliable monolithic ceramic capacitor can be manufactured even when the thickness of the ceramic green sheet is reduced to 5 μm or less.

Other Embodiments

The ceramic capacitors and the manufacturing method therefor of the present invention are not limited to the above preferred embodiments and are subject to various changes and modifications within the scope of the invention. For example, the molar ratio of CaZrO₃ to CaTiO₃ is not limited to the 6:4 ratio described in the above embodiments. Since the peak resolution is not affected by the ratio of CaZrO₃ to CaTiO₃, no limit is imposed as to the ratio and any desired ratio may be employed.

Moreover, the present invention can be applied not only to a monolithic ceramic capacitor but also to a single-layer ceramic capacitor.

Furthermore, the ceramic green sheets having the internal electrodes thereon are stacked and then sintered in the preferred embodiment. The method for making the ceramic capacitor is not limited to this and other methods may be employed. For example, the method comprising the steps of forming a ceramic insulating layer by printing or the like using a ceramic material paste, applying a conductive material paste onto the surface of the ceramic insulating layer to form an internal electrode, and applying the ceramic material paste thereon to form another ceramic insulating layer may be used. By repeating the above steps, a ceramic capacitor having a multilayer structure can be obtained.

As is apparent from the above, a CaZrO₃-CaTiO₃-based ceramic exhibiting a high solid solubility can be obtained according to the present invention, and a ceramic capacitor having a high reliability at high temperatures can be manufactured.

What is claimed is:

1. A ceramic capacitor comprising a ceramic CaZrO₃-CaTiO₃ solid solution and having a powder X-ray diffraction pattern which satisfies the conditions of:
(X-ray intensity of valley D)/(X-ray intensity of peak B)<0.2;
and
(X-ray intensity of valley E)/(X-ray intensity of peak B)<0.2,
wherein peak B is a peak in the X-ray diffraction pattern assigned to the (121) plane of the CaZrO₃-CaTiO₃ solid solution detected at approximately 32.0°, valley D is a valley in the X-ray diffraction pattern at approximately 31.8° lying between a peak A which is a peak in the X-ray diffraction pattern assigned to the (200) plane of the CaZrO₃-CaTiO₃ solid solution detected at approximately 31.6° and the peak B, and valley E is a valley in the X-ray diffraction pattern at approximately 32.2° lying between the peak B and a peak C which is a peak in the X-ray diffraction pattern assigned to the (002) plane of the CaZrO₃-CaTiO₃ solid solution detected at approximately 32.4°.

2. A ceramic capacitor according to claim 1, wherein said ceramic CaZrO₃-CaTiO₃ solid solution has a powder X-ray diffraction pattern which satisfies the conditions of:
(X-ray intensity of valley D)/(X-ray intensity of peak B)<0.187;
and
(X-ray intensity of valley E)/(X-ray intensity of peak B)<0.196.

3. A ceramic capacitor according to claim 2, wherein said ceramic CaZrO₃-CaTiO₃ solid solution has a powder X-ray diffraction pattern which satisfies the conditions of:
(X-ray intensity of valley D)/(X-ray intensity of peak B)≧0.158;
and
(X-ray intensity of valley E)/(X-ray intensity of peak B)≧0.177.

4. A ceramic capacitor according to claim 3 having a pair of external electrodes disposed on spaced apart external surfaces of said ceramic.

5. A ceramic capacitor according to claim 4 having a plurality of spaced apart internal electrodes disposed within said ceramic, at least one of said internal electrodes electrically connection to one of said external electrodes and at least one other of said internal electrodes electrically connection to the other of said external electrodes.

6. A ceramic capacitor according to claim 1 having a pair of external electrodes disposed on spaced apart external surfaces of said ceramic.

7. A ceramic capacitor according to claim 6 having a plurality of spaced apart internal electrodes disposed within said ceramic, at least one of said internal electrodes electrically connection to one of said external electrodes and at least one other of said internal electrodes electrically connection to the other of said external electrodes.

8. A method for manufacturing a material for a ceramic capacitor, comprising:
calcining CaCO₃, ZrO₂ and TiO₂ starting materials at a temperature in the range of about 1,100° C. to 1,200° C. to obtain a calcined stock;
adding at least one sintering aid to the calcined stock; and
sintering the resulting calcined stock at a temperature not less than about 1,300° C. to make a ceramic containing CaZrO₃ and CaTiO₃ as the primary components.

9. A method according to claim 8, further comprising prior to sintering the resulting calcined stock, shaping the resulting calcined stock into green sheets, applying a conductor to a surface portion of the green sheets and assembling into a laminate a plurality of the conductor containing green sheets such that adjacent conductors are separated by a green sheet.

10. A method according to claim 9, further comprising forming a pair of electrodes on external surfaces of the sintered ceramic.

11. A method according to claim 8, further comprising shaping the resulting calcined stock into green sheets, applying a conductor to a surface portion of a first green sheet and applying a second green sheet to a surface of the conductor opposite said first green sheet prior to sintering the resulting calcined stock.

12. A method according to claim 11, further comprising forming a pair of electrodes on external surfaces of the sintered ceramic.

13. A method according to claim 8, further comprising forming a pair of electrodes on external surfaces of the sintered ceramic.
